(19) United States
(12) Patent Application Publication
(10) Pub. No.: US 2016/0259402 A1
(43) Pub. Date: Sep. 8, 2016

(54) CONTACT DETECTION APPARATUS, PROJECTOR APPARATUS, ELECTRONIC BOARD APPARATUS, DIGITAL SIGNAGE APPARATUS, PROJECTOR SYSTEM, AND CONTACT DETECTION METHOD

(71) Applicants: Koji MASUDA, Kanagawa (JP); Kimiya AOKI, Aichi (JP); Yuki TACHIBANA, Aichi (JP)

(72) Inventors: Koji MASUDA, Kanagawa (JP); Kimiya AOKI, Aichi (JP); Yuki TACHIBANA, Aichi (JP)

(21) Appl. No.: 15/054,701

(22) Filed: Feb. 26, 2016

(30) Foreign Application Priority Data
Mar. 2, 2015 (JP) 2015-039929

(51) Int. Cl. G06F 3/00; H04N 9/31

(52) U.S. Cl. CPC G06F 3/005; H04N 9/31

(57) ABSTRACT

A contact detection apparatus detects contact of a contactor and a contacted object. The contact detection apparatus includes an imager that acquires three-dimensional imaging information of the contactor and the contacted object, a setter that sets a contact target surface based on the three-dimensional imaging information of the contacted object from the imager, a candidate detector that converts the three-dimensional imaging information of the contactor from the imager into two-dimensional information and detects an end portion candidate of the contactor based on the two-dimensional information and the contact target surface, and a contact determiner that decides an end portion of the contactor and determines the contact of the contactor and the contacted object based on the three-dimensional imaging information of the end portion candidate and the contact target surface.

### CROSS-REFERENCE TO RELATED APPLICATION

This application is based upon and claims the benefit of priority to Japanese Patent Application No. 2015-039929, filed on Mar. 2, 2015, the entire disclosures of which are incorporated herein by reference.

### BACKGROUND

1. Technical Field

The present invention relates to a contact detection apparatus, a projector apparatus, an electronic board apparatus, a digital signage apparatus, a projector system, and a contact detection method. More specifically, the present invention relates to a contact detection apparatus that detects contact of a contactor and a contacted object, a projector apparatus having the contact detection apparatus, an electronic board apparatus having the contact detection apparatus, a digital signage apparatus having the contact detection apparatus and a projector system having the projector apparatus, and a contact detection method of detecting the contact of the contactor and the contacted object.

2. Description of Related Art

In recent years, so-called interactive projector apparatuses each having functions of writing a letter and a drawing in a projection image projected on a screen and executing operation such as enlargement and reduction of the projection image, and page feeding are commercially available. These functions are achieved by setting as an input operator (contactor) a finger of a user or a pen or pointer which the user has, which touch the screen, detecting a position where a tip of the input operator is in contact with the screen (contacted object) and movement of the position, and sending a detection result to a computer and so on.

For example, JP2014-202540A discloses a position calculation system. The position calculation system includes an acquisition part that acquires images of an object imaged by a plurality of cameras in time series, a calculation part that calculates a distance from the cameras to the object based on the images, a correction part that corrects the calculated distance to a distance from the cameras to a predetermined X-Y plane when a difference of areas of the object among the plurality of images acquired in the time series is a predetermined threshold or less, in a case where the object reaches the X-Y plane.

JP2008-210348A discloses an image display apparatus. The image display apparatus includes a detector a fingertip in a predetermined range from a screen of a display, from an image imaged by an imager, a three-dimensional coordinate calculator that calculates a three-dimensional coordinate of the detected fingertip, a coordinate processor that corresponds the calculated three-dimensional coordinate of the fingertip to a two-dimensional coordinate on the screen of the display, and an image displayer that displays an image of a lower-order layer of an image displayed now on the screen of the display in accordance with a distance among the corresponded two-dimensional coordinate on the screen of the display and the fingertip and the screen of the display.

JP2012-48393A discloses an information processing apparatus. The information processing apparatus includes a detector that detects an object (contactor) existing on a predetermined surface at a notable point by use of a distance image sensor, a specifying device that specifies an end of the object from a color image where a position of the object detected at the notable point and circumference of the position are imaged, an estimation device that estimates a position of the specified end based on the position of the object, and a determination device that determinates contact of the contactor and a contacted object according to the position of the end.

JP2013-8368A discloses an automatic switching system of an interactive mode in a virtual touch screen system. The automatic switching system includes a projector that projects an image on a projection surface, a depth camera that continuously acquires images of environment of the projection surface, a depth map processor that forms an initial depth map by depth information acquired from the depth camera at an initial state, an object detector, and that decides a position of a touch operation area by the initial depth map, an object detector that detects at least one candidate blob of an object (contactor) set in a predetermined time interval before the touch operation area is decided from each of the images continuously acquired by the depth camera after the initial state, and a tracking device that inputs each blob in a corresponding point arrangement from a relationship between time and space in a center of gravity of the blob acquired from forward and rearward adjacent images.

### SUMMARY

However, the systems and the apparatuses disclosed in prior art references as described above have room for improvement in the detection of the contact of the contactor and the contacted object.

A contact detection apparatus according to one embodiment of the present invention detects contact of a contactor and a contacted object. The contact detection apparatus includes an imager that acquires three-dimensional imaging information of the contactor and the contacted object, a setter that sets a contact target surface based on the three-dimensional imaging information of the contacted object from the imager, a candidate detector that converts the three-dimensional imaging information of the contactor from the imager into two-dimensional information and detects an end portion candidate of the contactor based on the two-dimensional information and the contact target surface, and a contact determiner that decides an end portion of the contactor and determines the contact of the contactor and the contacted object based on the three-dimensional imaging information of the end portion candidate and the contact target surface.

According to the contact detection apparatus, it is possible to accurately detect the contact of the contactor and the contacted object and a position of the contactor at that time.

### BRIEF DESCRIPTION OF DRAWINGS

FIG. 1 is a perspective view showing a schematic configuration of a projector system according to one embodiment of the present invention.

FIG. 2 is an explanatory view for explaining a state where an image is projected on a screen by a projector apparatus.

FIG. 3 is a block view showing a distance measurer.

FIG. 4 is a perspective view showing a casing containing a light emitter and an imager.

FIG. 5 is a diagram view showing a schematic configuration of the imager.

FIG. 6 is a flow chart for explaining preprocessing executed by a processor.

FIG. 7 is a flow chart for explaining processing of acquiring input operation information executed by the processor.

FIG. 8 is an explanatory view for explaining a first example of the processing of acquiring input operation information.

FIG. 9 is a photograph for explaining one example of a finger area in which projection conversion is executed.

FIG. 10 is a photograph for explaining a case where down-sampling of the finger area shown in FIG. 9 is executed.

FIG. 11 is a photograph for explaining convex hull processing of the finger area shown in FIG. 9.

FIG. 12 is a photograph showing a result of the convex hull processing in FIG. 10.

FIG. 13 is an explanatory view for explaining a second example of the processing of acquiring input operation information.

FIG. 14 is an explanatory view for explaining a third example of the processing of acquiring input operation information.

FIG. 15 is an explanatory view for explaining a first modified example of the projector apparatus.

FIG. 16 is an explanatory view for explaining a first modified example of the distance measurer.

FIG. 17 is an explanatory view for explaining a second modified example of the distance measurer.

FIG. 18 is an explanatory view for explaining one case of a third modified example of the distance measurer.

FIG. 19 is an explanatory view for explaining another case of a third modified example of the distance measurer.

FIG. 20 is an explanatory view for explaining a second modified example of the projector apparatus.

FIG. 21 is an explanatory view for explaining a case where a surface of a contacted object has a step.

FIG. 22 is an explanatory view for explaining a case where the surface of the contacted object has a curved surface.

FIG. 23 is a perspective view showing one example of an electronic board apparatus.

FIG. 24 is a schematic front view showing one example of a digital signage apparatus.

### DETAILED DESCRIPTION

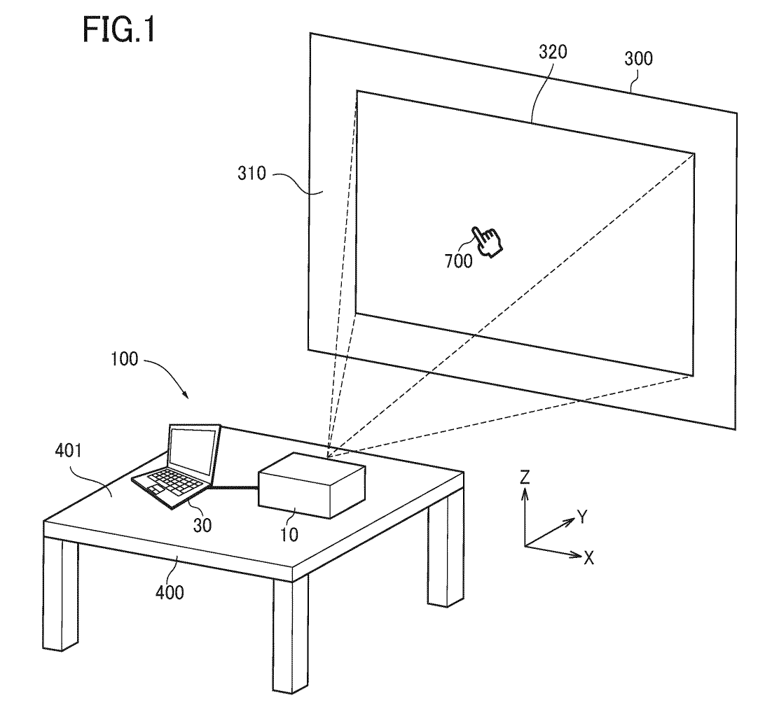

One embodiment of the present invention will be described hereinafter with reference to FIGS. 1 to 14. FIG. 1 illustrates an example of a projector system 100 according to the one embodiment.

The projector system 100 includes a projector apparatus 10 and an image management apparatus 30. An operator (user) executes input operation for an image (projection image 320) projected on a projection surface 310 of a screen 300 by coming in contact with a close position to the projection surface 310 of the screen 300 or on the projection surface 310 by an input operator 700 such as a finger of the user, pen, indicator or the like. In the embodiment, there is a case where the screen 300 is referred to as a contacted object, and the input operator 700 is referred to as a contactor. The projection image 310 may be either a static image or moving image.

The projector apparatus 10 and the image management device 30 are placed on a disk, table, exclusive pedestal or the like (hereinafter, referred to as a mounter 400). Here, three-dimensional perpendicular coordinate axes X, Y, and Z (see FIG. 1) are used, and a direction perpendicular to a placement surface 401 of the mounter 400 is defined as a Z axis direction. The screen 300 is also disposed in a +Y side of the projector apparatus 10. The projection surface 310 corresponds to a surface of −Y side of the screen 300. Note that a board surface of a white board, wall surface, or the like may be used as the projection surface 310.

The image management device 30 stores a plurality of image data and sends image information (hereinafter referred to as projection image information) of a projection object to the projector apparatus 10 based on instructions of the user. Communication between the image management apparatus 30 and the projector apparatus 10 may be either cable communication that communicates through a cable such as a universal Serial Bus (USB), or wireless communication. A personal computer in which a predetermined program is installed can be used as the image management device 30.

In a case where the image management device 30 has an interface of an attachable and detachable recording medium such as a USB memory, secure digital (SD) card or the like, an image stored in the recording medium may be used as the projection image.

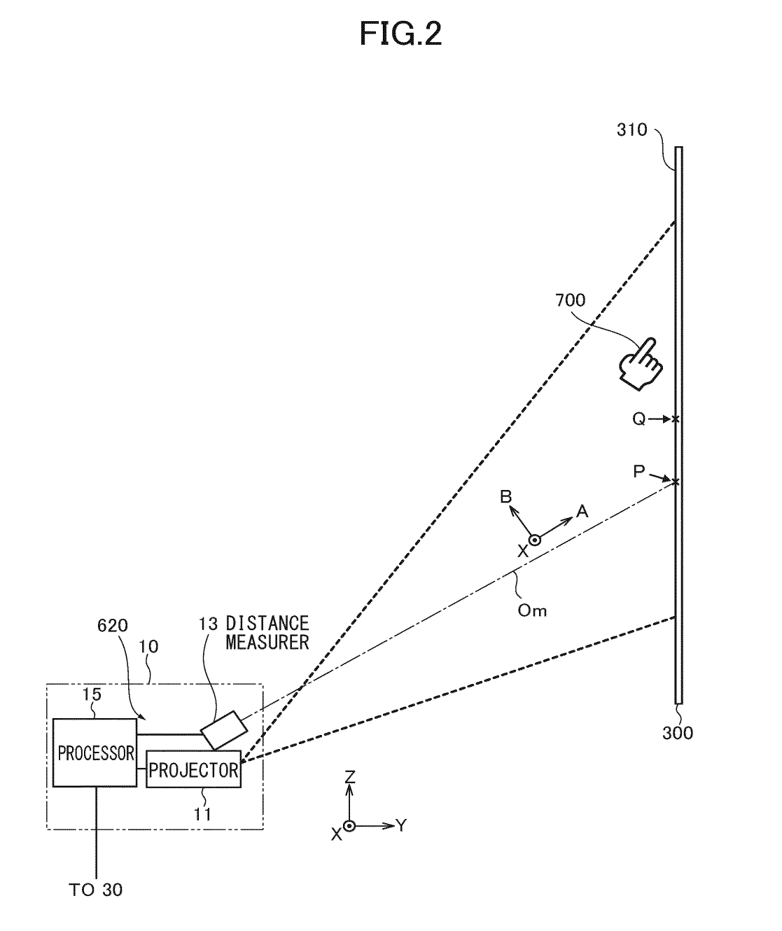

The projector apparatus 10 is a so-called interactive projector apparatus. The projector apparatus 10 includes a projector 11, a distance measurer 13, and a processor 15, as shown in FIG. 2. The projector 11, the distance measurer 13, and the processor 15 are contained in a casing 135 (see FIG. 4).

In the projector apparatus 10 of the embodiment, a contact detection apparatus 620 (see FIG. 2) according to the present embodiment is composed of the distance measurer 13 and the processor 15.

The projector 11 includes a light source, a color filter, various light elements, and so on and is controlled by the processor 15, in the same manner as a conventional projector apparatus.

The processor 15 executes tow-way communication between the processor and the image management device 30. When the processor 15 receives projection image information, it executes a predetermined image processing for the information, and is configured to project the processed image on the screen 300 by the projector 11.

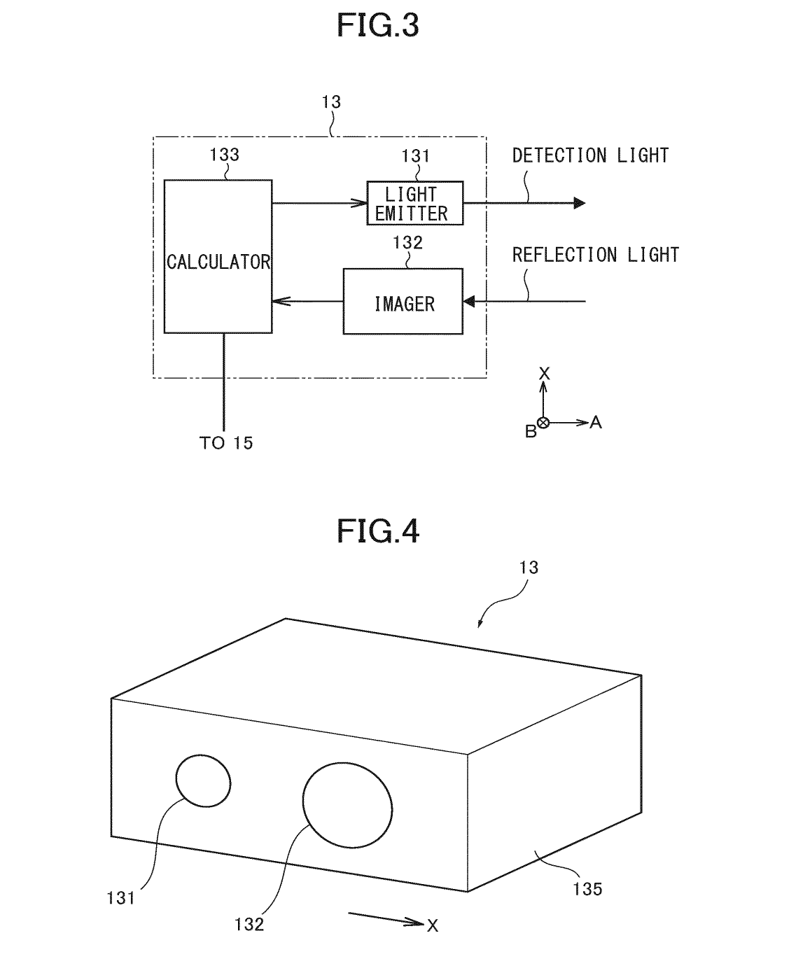

The distance measurer 13 includes a light emitter 131, an imager 132, a calculator 133, and so on, as one example, as shown in FIG. 3. The distance measurer 13 configures an imaging device as described below. An external appearance of the distance measurer 13 is shown in FIG. 4 as one example. Here, the light emitter 131, the imager 132, and the calculator 133 are contained in the casing 135 (see FIG. 4), as described above. However, a light-emitting portion of the light emitter 131 and an opening of a lens of the imager 132 are exposed from a wall of the casing 135, as shown in FIG. 4.

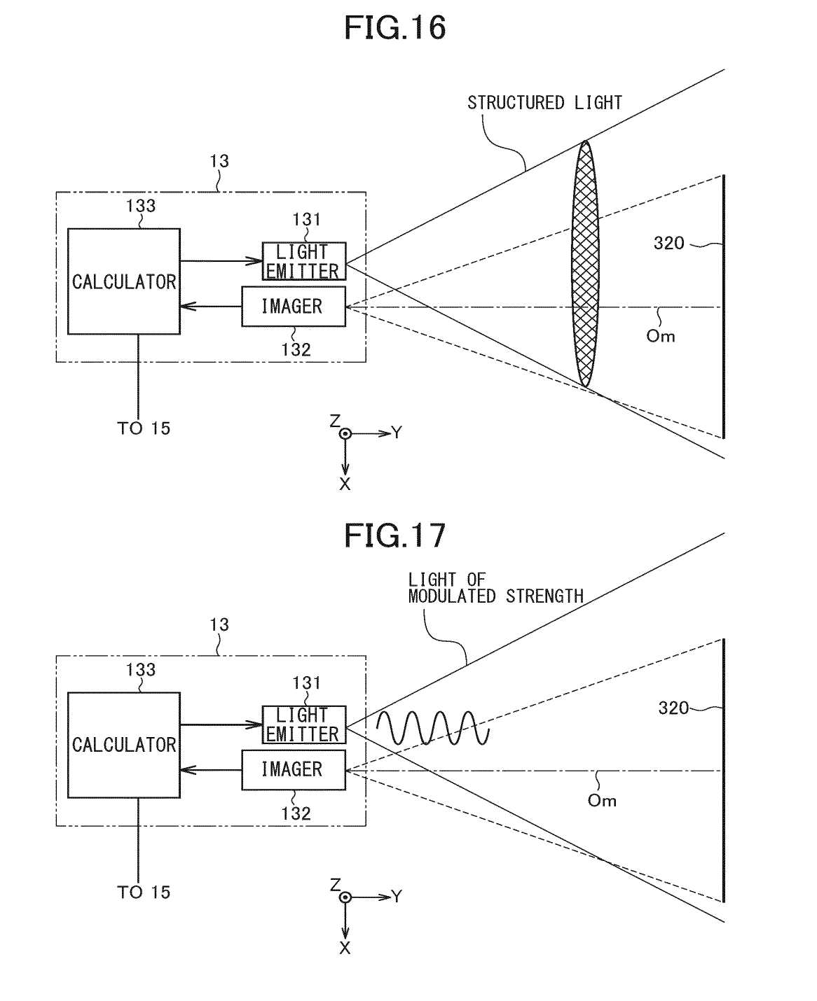

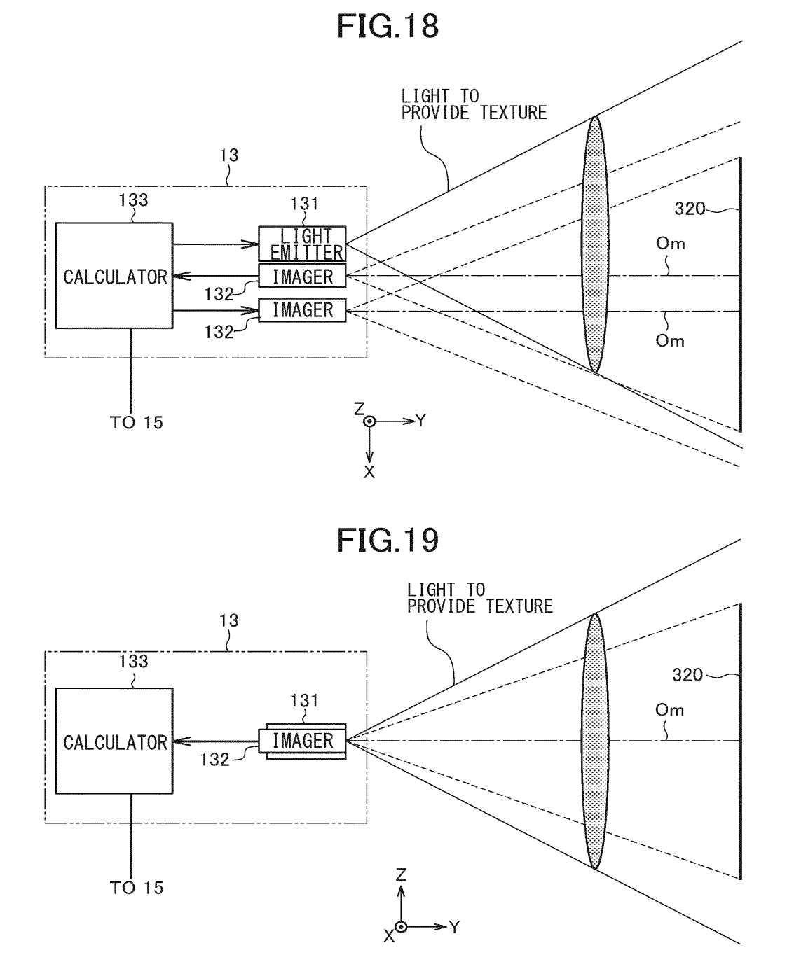

The light emitter 131 has a light source that emits detection light of near infrared light and irradiates the projection image with the detection light. The light source is controlled to be turned ON and turned OFF by the processor 15. As the light source, a light-emitting diode (LED), semiconductor laser (LD) or the like may be used. An optical filter or filter may be used to adjust the detection light emitted from the light source. In this case, for example, it is possible to adjust a light-emitting direction (angle) of the detection light, form the detection light as light structuring the detection light (see FIG. 16), form the detection light as light for modulating strength (see FIG. 17), or form the detection light as light providing an imaging object with texture (see FIG. 18).

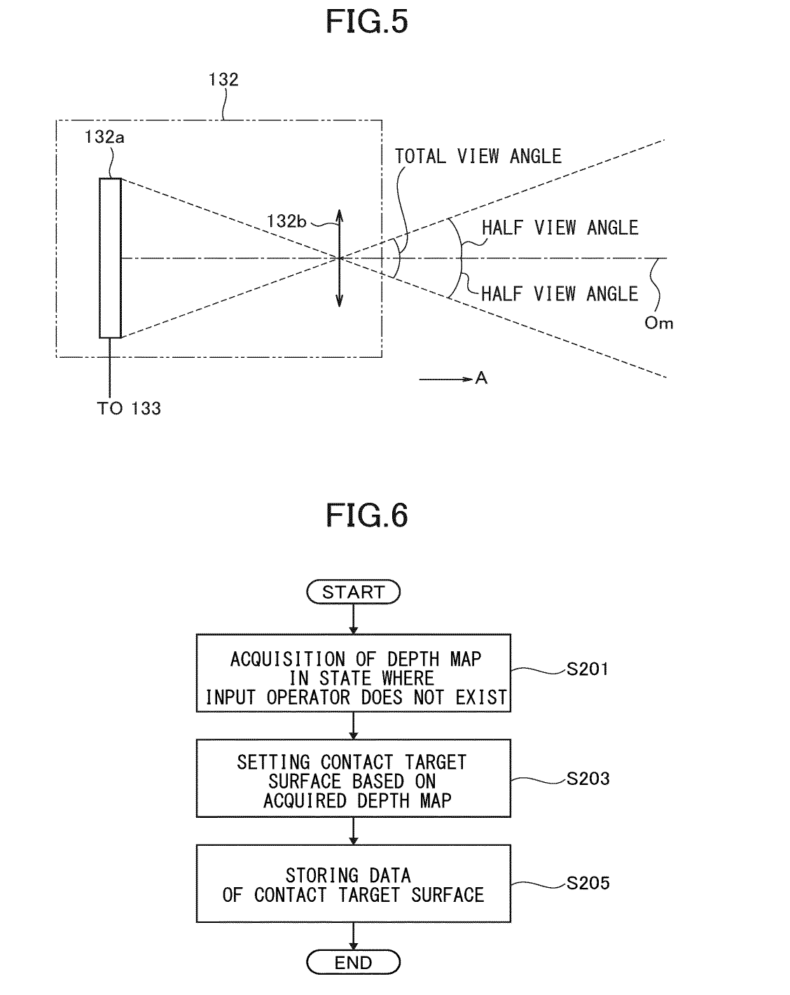

The imager 132 includes an imaging element 132a and an imaging optical system 132b, as one example, as schematically shown in FIG. 5. The imaging element 132a is an area-type imaging element. The imaging element 132a has a rectangular shape. The imaging optical system 132b guides the detection light emitted from the light emitter 131 and reflected on the imaging object to the imaging element 132a. Here, since the imaging element 132a is the area type, it is possible to collectively acquire two-dimensional information even if a light deflector such as a polygon mirror is not used.

Here, in the embodiment, the imaging object of the imager 132 is referred to as the projection surface 310 on which the projection image 320 is not projected, the projection image 320 projected on the projection surface 310, or the input operator 700 and the projection image 320.

The imaging optical system 132b is a so-called coaxial optical system, and an optical axis of the imaging optical system is defined. Note that the optical axis of the imaging optical system 132b is also described hereinafter as an optical axis Om of the distance measurer 13 as a matter of convenience, as shown in FIG. 2. Here, a direction parallel to the optical axis of the distance measurer 13 is defined as an A axis direction and a direction perpendicular to the A axis direction and the X axis direction is defined as a B axis direction (see FIG. 2). A view angle of the imaging optical system 132b is set such that all areas of the projection image 320 can be imaged.

Returning to FIG. 2, the distance measurer 13 is disposed such that the A axis direction is a direction inclining counterclockwise to a Y axis direction and a position P where the optical axis Om of the distance measurer 13 intersects with the projection surface 310 becomes a side of −Z from a center Q of the projection image 320. In other words, with respect to the Z axis direction, the arranged position of the distance measurer 13 and the position P where the optical axis Om of the distance measurer 13 intersects with the projection image 320 are in the same side in the −Z side from the center Q of the projection image 320.

The calculator 133 calculates distance information to the imaging object based on an emitting timing of the detection light from the light emitter 131 and an imaging timing of the reflection light in the imaging element 132a. In addition, three-dimensional information of an imaged image of the imaging object, that is to say, a depth map is acquired. Not that a center of the acquired depth map is on the optical axis Om of the distance measurer 13.

The calculator 133 acquires the depth map of the imaging object with a predetermined time interval (frame rate) and notices it to the processor 15.

The processor 15 detects the contact of the input operator 700 and the projection surface 310 based on the depth map acquired by the calculator 133 and obtains a position and movement of the input operator 700 to acquire input operation information corresponding to the position and the movement of the input operator 700. The processor 15 further notices the input operation information to the image management device 30.

When the image management device 30 receives the input operation information from the processor 15, it executes image control according to the input operation information. Thereby, the input operation information is reflected on the projection image 320.

Next, preprocessing executed by the processor 15 is described with reference to a flow chart illustrated in FIG. 6. The preprocessing is executed in a state where the input operator 700 does not exist in an imaging area of the imager 132, as in a state where a power source is turned on or before the input operation is started.

In the first step S201, the depth map in a state where the input operator 700 does not exist, that is to say, three-dimensional information of the projection surface is acquired from the calculator 133.

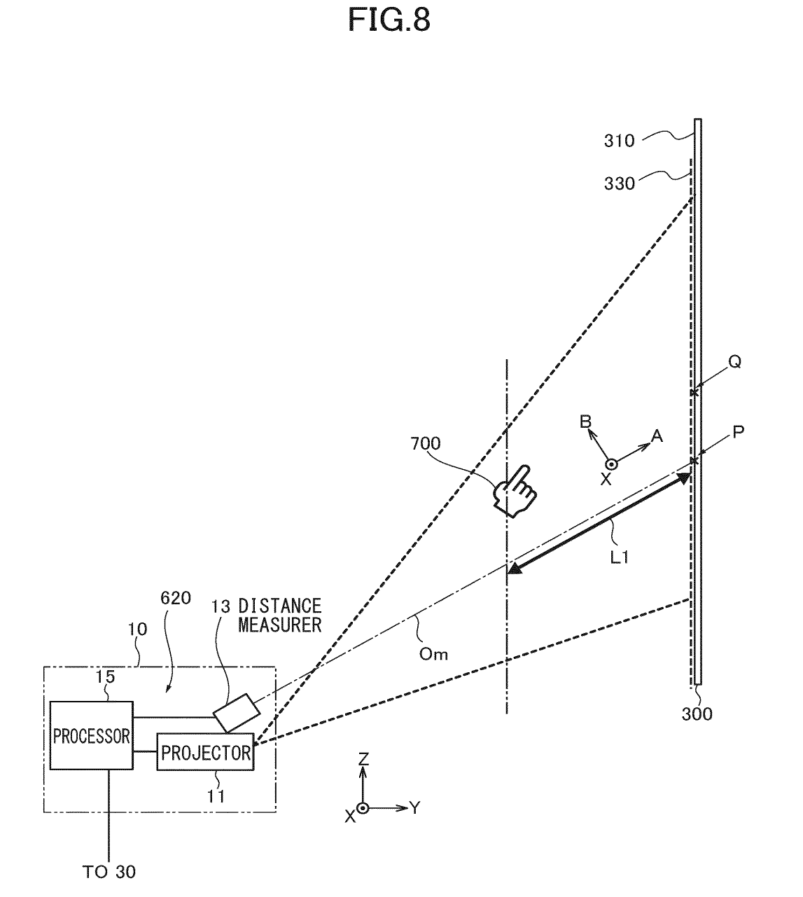

In the next step S203, a contact target surface 330 is set based on the acquired depth map. In the embodiment, a surface remote by 3 mm from the projection surface 310 is set to be the contact target surface 330 in the A-axis direction in the three-dimensional information of the projection surface 310 (see FIG. 8).

By the way, a measurement error in the distance measurer 133 is included in the depth map from the calculator 133. Therefore, there is a case that a measured value of the depth map enters an inside of the screen 300 (+Y side of the projection surface 310). In view of this, a quantity of the measurement error in the distance measurer 133 is added to the three-dimensional information of the projection surface 310 as an offset.

Here, the value of 3 mm of the surface remote from the projection surface 310 is one example, and it is preferable to set the position of the contact target surface 330 to a degree of measurement error (for example, a standard deviation σ) of the distance measurer 13.

In a case where the measurement error of the distance measurer 13 is small, or the offset is not required, the three-dimensional information itself of the projection surface 310 may be set to be the contact target surface.

The contact target surface 330 has data for every a pixel without being expressed with an approximate equation to be one plane as a whole. Note that, if the contact target surface 330 includes a curved surface or step, the contact target surface is divided in a plurality of minute planes, and median processing or averaging processing is executed for every the minute plane to remove an abnormal value and to have data for every the pixel.

In the next step S205, the set three-dimensional data of the contact target surface 330 are stored as data for every the pixel. Here, the set three-dimensional data of the contact target surface 330 are also referred hereinafter to as “contact target surfaced data”.

By the way, the implementation of the preprocessing is not limited to the execution made when the power source is turned on or before the input operation is started. For example, if the projection surface 310 is deformed over time, the preprocessing may be suitably implemented without using the input operator 700.

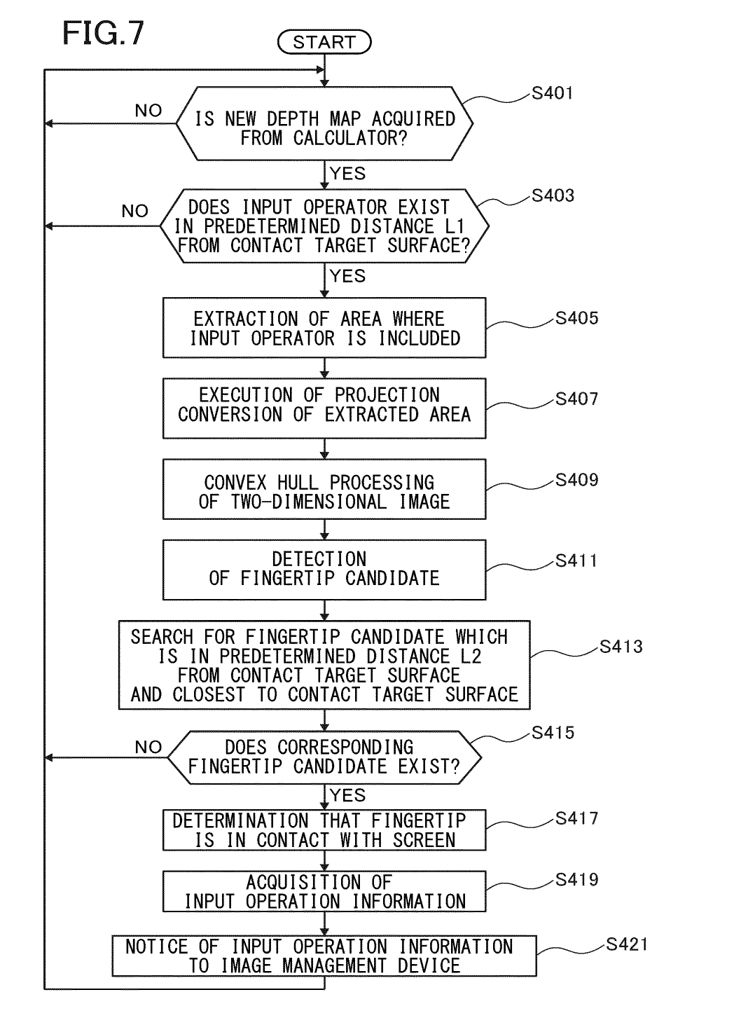

Subsequently, processing of acquiring input operation information executed by the processor 15 when the interactive operation is executed is described with reference to a flow chart illustrated in FIG. 7 as follows. Here, the input operator 700 is used as the finger of the user, but is not limited to this, for example, may use the pen or the pointer.

In the first step S401, whether a new depth map is sent from the calculator 133 is determined if the new depth map has not yet been sent from the calculator 133, the determination here is negated and the user stands by the sending of the new depth map from the calculator 133. On the other hand, if the new depth map has been sent from the calculator 133, the determination here is affirmed and the flow proceeds to step S403.

Here, the depth map corresponds to a depth map of a state where the input operator 700 exists in the imaging area of the imager 132.

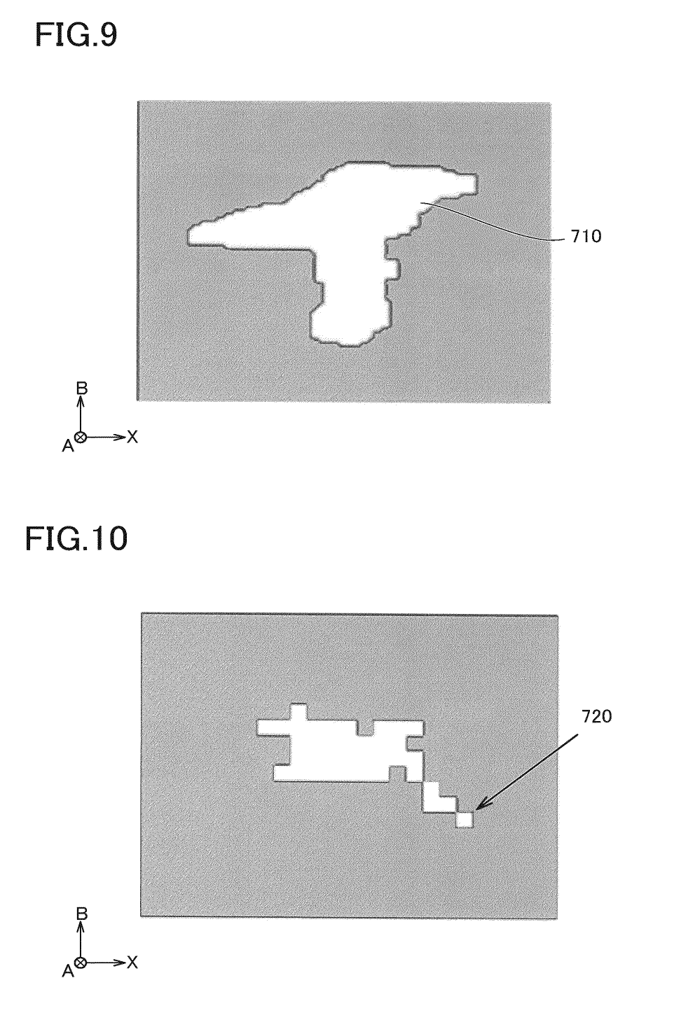

In step S403, whether the input operator 700 exists in a predetermined distance L1 (see FIG. 8) from the contact target surface with respect to the −A direction is determined based on the depth map from the calculator 132 and the stored contact target surface data. If the input operator 700 exists in the predetermined distance L1 from the contact target surface, the determination here is affirmed, the flow proceeds to step S405. Here, the predetermined distance L1 is set to be 100 mm as one example. For convenience of explanation, an area of the input operator in the depth map is also referred to as a finger area 710 (see FIG. 9). The finger area 710 is described below with reference to FIG. 9.

That is to say, the input operator 700 existing at a position exceeding the predetermined distance L1 from the contact target surface with respect to the −A direction is regarded as unrelated to contact and subsequent processing is not executed. Thereby, excess processing is removed and calculation load can be reduced.

In step S405, the finger area is extracted from the depth map.

By the way, in the embodiment, a configuration is made to correspond to a plurality of input operators. For example, when two input operators exist, at least two finger areas are extracted. The at least two mean that there are areas incorrectly extracted as the finger areas. For example, when an arm, an elbow, a part of a cloth, and so on enter the predetermined distance L1 from the contact target surface with respect to the −A direction, they incorrectly extracted as the finger areas. Note that as for the incorrect extraction at this step, it is preferable from the viewpoint of the calculation load that the incorrect extraction is small or does not exist at this step, but there is not inconvenience even if it exists.

Here, the predetermined distance L1 is set to be 100 mm, but this value is one example. However, if the value of L1 is small too, the extracted finger area becomes small, and hence subsequent image processing is difficult. On the other hand, if the value of L1 is large too, the number of extracted errors increases. In the experiment of the inventors and so on, a range of 100 mm to 300 mm is preferable as the value of L1.

In the next step S407, the extracted finger area is converted by projection conversion. Thereby, the three-dimensional information of the finger area is converted into the two-dimensional information. In the embodiment, by applying a pinhole camera model to the distance measurer 13, the projection conversion is executed on a plane perpendicular to the optical axis Om of the distance measurer 13. The conversion of the three-dimensional information into the two-dimensional information causes the subsequent image processing to simply and the calculation load to reduce.

FIG. 9 illustrates one example of the finger area in which the projection conversion is executed. In FIG. 9, a white portion corresponds to the finger area 710. In the example, a silhouette of a half portion of a hand and a finger of an adult is appeared as the input operator 700. FIG. 10 illustrates the depth map in a case where it is downsized to be 1/10 in the example illustrated in FIG. 9. In FIG. 10, reference numeral 720 denotes a tip of the input operator 700.

Note that, for the converted two-dimensional information, an area of the image is calculated, and other than information existing in a predetermined range is removed as not the finger area 710. This is because it is considered that a small area is clearly noise, whereas a large area is clearly not a portion including a fingertip such as a user's body, a cloth and so on. With this processing, a subsequent calculation load is reduced.

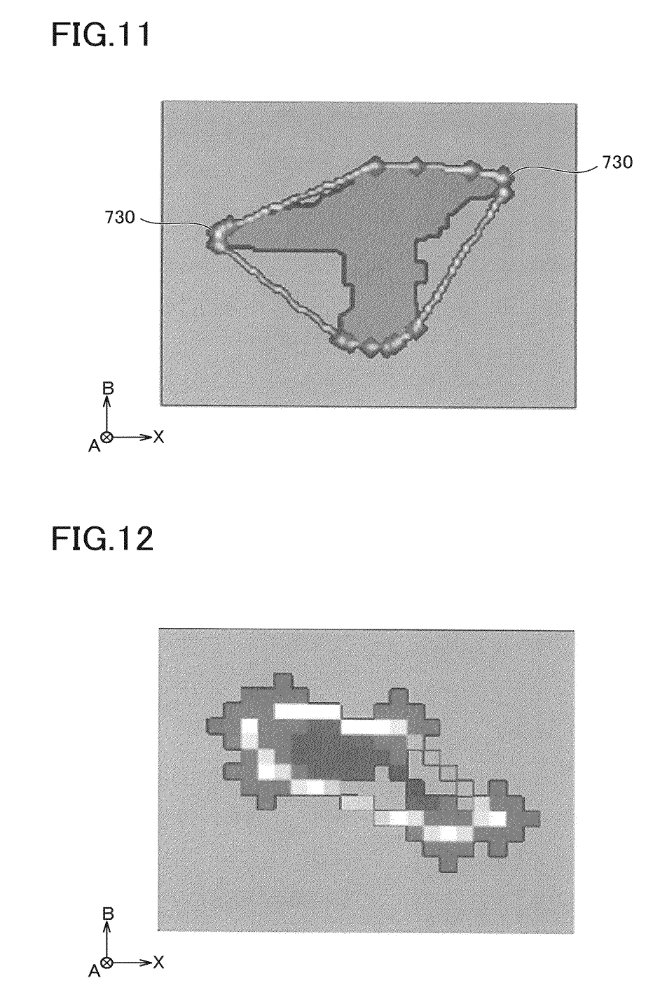

In the next step S409, convex hull processing is executed with respect to the two-dimensional image of the finger area. Here, the convex hull processing is to obtain a minimum convex polygon including each of some points of the finger area which is the white portion. Note that, in a case of a plurality of finger areas, the convex hull processing is executed to each of the finger areas. FIG. 11 illustrates a result of the convex hull processing of the finger area shown in FIG. 9. FIG. 12 illustrates a result of convex hull processing of the depth map shown in FIG. 10.

In the next step S411, detection to acquire finger candidate every the finger area is executed. A plurality of vertexes 730 (see FIG. 11) acquired by the convex hull processing is considered to be a finger candidate in the finger area.

The processing here is executed for each of the finger areas. Note that a j^{th} vertex (that is, a candidate point) by the convex hull processing in an i^{th} finger area Ri is written to be Kij.

By the way, as a method of extracting the tip 720 of the input operator 700, a pattern matching method using a template is considered. However, the method results in significant reduction of detection rate in a case where the two-dimensional information differs from the template. In addition, to execute the pattern matching, an image having corresponding resolution (number of pixels) is needed as the template. On the other hand, in the convex hull processing, if one pixel exists at the tip as the ultimate, the tip 720 can be detected as the vertex (candidate point).

For example, when viewing the silhouette in FIG. 10, the tip 720 has actually only one pixel. However, it is understood that the tip 720 can be accurately detected as the vertex (that is, the candidate point), as shown in FIG. 12.

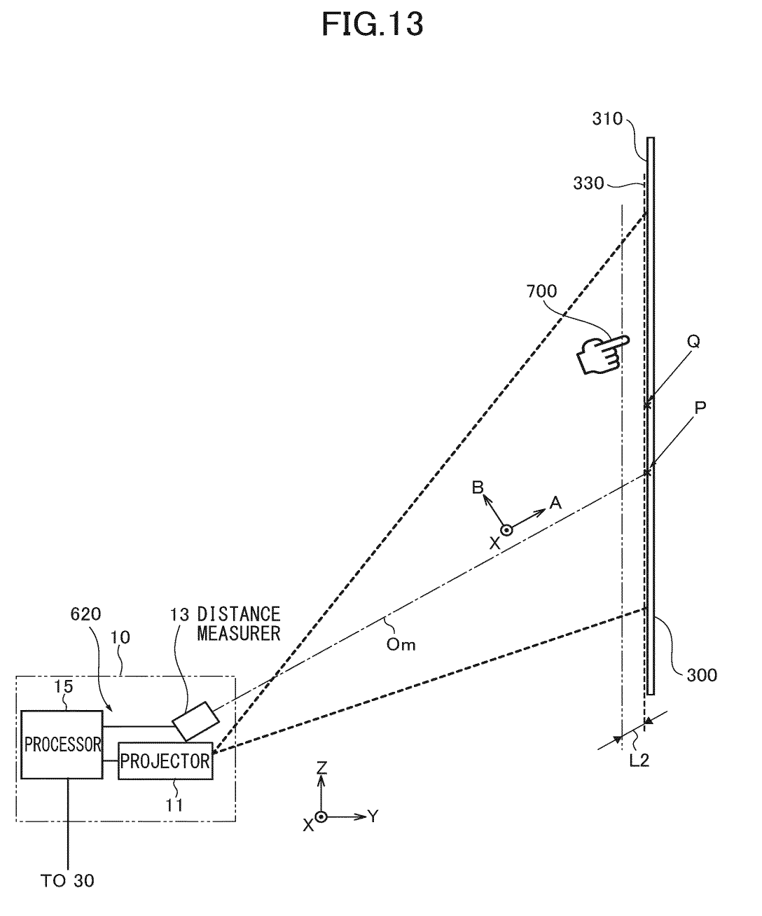

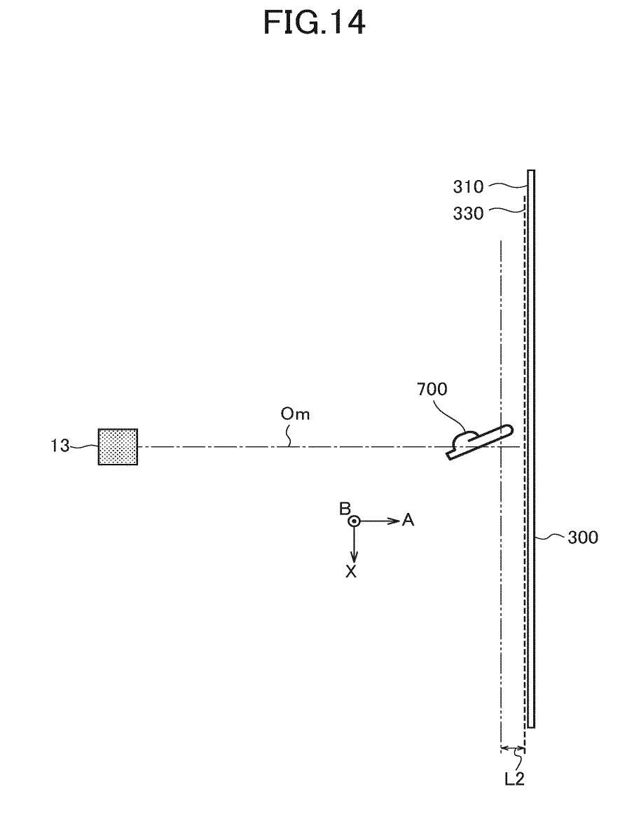

In the next step S413, the finger candidate which is within a predetermined distance L2 (see FIGS. 13 and 14) from the contact target surface 330 with respect to the −A direction and closest to the contact target surface 330 every the finger area is searched by referring to the stored data of the contact target surface 330. Here, the predetermined distance L2 is 30 mm as one example.

In the next step S415, by referring to the searched result, whether the corresponding finger candidate exists is determined. When the corresponding finger candidate exists, the determination here is affirmed, the flow proceeds to step S417.

In this step, step S417, the corresponding finger candidate is regarded as the fingertip in the finger area, and it is determined that the fingertip comes in contact with the screen 300.

In the embodiment, the tip 720 of the input operator 700 necessarily exists on the depth map from the derivation process as described above. The vertex determined as to whether the input operator 700 comes in contact with the contact target surface corresponds to a vertex of the tip.

In the next step S419, the input operation information is obtained based on the contact state and the contact position of the fingertip. For example, if the contact is made for a short time of a degree one frame or several frames, the input operation information is determined as input operation which is clicking. On the other hand, if the contact continues and the position moves between the frames, the input operation information is determined as input operation which writes characters or lines.

In the next step S421, the acquired input operation information is notified to the image management device 30. Thereby, the image management device 30 executes image control depending on the input operation information. In other words, the input operation information is reflected on the projected image 320. Then, the flow returns to step S401 as described above.

In the above-mentioned step S403, if the contactor does not exist in the predetermined distance L1 from the contact target surface with respect to the −A direction, the determination in the step S403 is negated, and the flow returns to step S401.

In addition, in the above-mentioned step S415, if the corresponding fingertip candidate does not exist, the determination in the step S415 is negated, and the flow returns to step S401.

In this way, the processor 15 has functions of setting the contact target surface 330, extracting the finger area, detecting a tip candidate, and determining the contact of the contactor and the contacted object. These functions may be executed by processing according to a program by a CPU, hardware, or the processing according to the program by the CPU and the hardware.

In the embodiment, the processing of acquiring the depth map in the calculator 133, the processing of setting the contact target surface in the processor 15, and the processing of extracting the finger area are respectively the three-dimensional processing. The processing of setting the contact target surface in the processor 15 and the processing of extracting the finger area use only the depth map. Furthermore, the processing of detecting the tip candidate in the processor 15 is the two-dimensional processing. In addition, the processing of executing the contact determination in the processor 15 is the three-dimensional processing.

In this way, in the embodiment, the tip candidate of the input operator 700 is detected by using the depth map and combining the three-dimensional processing and the two-dimensional processing, and the decision and the contact determination of the tip are simultaneously executed by refining the tip candidate. In this case, it is possible to accomplish simplification of algorithm with respect to a method of executing the contact determination after deciding the tip and correspond even in moving the input operator with a high speed.

Here, although the value of L2 is 30 mm, the value is one example. The value of L2 is strictly 0 mm in the contact between the contact target surface 330 and the tip of the input operator 700. However, in fact, it is preferable to set the value of several millimeters to several centimeters as the value of L2 because the calculator 133 has a measurement error and even if the contact target surface 330 and the tip of the input operator 700 are not in contact with each other, if they come close to each other, it is easy to treat as the contact.

As is clear from the foregoing description, according to the embodiment, the imaging device is composed of the distance measurer 13 and the setter, the candidate detector, and the contact determiner are composed of the processor 15. In other words, the contact detection apparatus 620 is composed of the distance measurer 13 and the processor 15.

A contact detection method is implemented in the processing executed by the processor 15.

As described above, the projector apparatus 10 according to the embodiment includes the projector 11, the distance measurer 13, and the processor 15 (see FIG. 2).

As illustrated in FIG. 2, the projector 11 projects an image (projection image) on the screen 300 based on the instructions of the processor 15. As illustrated in FIG. 13, the distance measurer 13, in other words, the imaging device includes the light emitter 131 that emits the light for detection (the detection light) to the projection image 320, the imager 132 that includes the imaging optical system 132b and the imaging element 132a and images at least one of the projection image 320 and the input operator 700, and the calculator 133 that acquires the depth map from the imaging result of the imager 132.

As described above, the processor 15 has the functions of setting the contact target surface, extracting the finger area, detecting the tip candidate, and determining the contact. The processor 15 detects the contact of the input operator 700 and the screen 300 based on the depth map from the distance measurer 13 to acquire the input operation information that the input operator 700 indicates.

When detecting the contact of the input operator 700 and the screen 300, the processor 15 extracts the finger area based on the depth map of the three-dimensional information and converts the finger area into the projection conversion of the two-dimensional information to the fingertip candidate. The processor 15 carefully examines the fingertip candidate based on the three-dimensional information and simultaneously executes the decision of the fingertip position and the contact determination. Here, the fingertip candidate is on the depth map and the contact determination is executed in relation to the fingertip candidate. Therefore, the fingertip position and the contact determination position are identical. In addition, since the contact determination is executed with respect to each fingertip candidate, when it is determined that the fingertip is in contact with the screen, simultaneously therewith, it is decided that the contactor or input operator is the fingertip.

In this way, it is possible to accurately detect the contact of the input operator 700 and the screen 300 and the position of the input operator 700 at that time. Therefore, it is possible to accurately acquire the input operation information.

In the function of setting the contact target surface by the processor 15, the contact target surface 330 is set to be the position separated by the predetermined distance from the screen 300. In this case, the input operator can be mathematically prevented from entering the inside (+Y side of the projection surface 310) of the screen 300 by estimating the measurement error of the distance measurer 13.

In the function of extracting the finger area by the processor 15, when the input operator 700 exists in the predetermined distance L1 from the contact target surface 330 with respect to the −A direction, an area including the input operator is extracted. In this case, as a pre-step detecting the tip candidate, a portion where a distance from the contact target surface 330 exceeds L1 regards as to be irrelevant to the contact, and excessive information can be deleted and the processing can be reduced.

In the function of detecting the tip candidate in the processor 15, the three-dimensional information is converted into the two-dimensional information by the projection conversion, and the convex hull processing is executed to the two-dimensional information to detect the tip candidate. In this case, even if the image has a low resolution, if there is at least one pixel in the tip portion, it is possible to detect the tip candidate.

In the function of determining the contact in the processor 15, it is decided that a distance from the contact target surface with respect to the −A direction is the predetermined value L2 or less, and the tip candidate closest to the contact target surface is the tip portion of the input operator 700, and it is determined that the input operator 700 is in contact with the screen 300. In this case, even if the input operator is a state of non-contact with the screen 300, if the input operator 700 is close to the contact target surface 330, the input operator 700 can be determined to be in contact with the screen. Therefore, the determination that the input operator 700 is in contact with the screen 300 can be made, even if the user does not want to directly being in contact with the screen 300 in a case of where many and unspecified persons employ or the input operator is dirty.

In addition, the light emitter 131 of the distance measurer 13 emits near infrared light. In this case, even under the environment with much visible light, the calculator 133 can acquire a depth map having a high accuracy. A defect which becomes hard to see the image can be restrained by interference of the light emitted from the light emitter 131 and the image (visible light) projected from the projector apparatus 10.

The imaging element 132a of the distance measurer 13 has a two-dimensional imaging element. In this case, the depth map can be acquired with one shot.

The projector system 100 according to the embodiment includes the projector apparatus 10. As a result, it is possible to correctly execute desired image display operation.

In the foregoing embodiment, the projector apparatus 100 and the image management device 30 may be integrally configured.

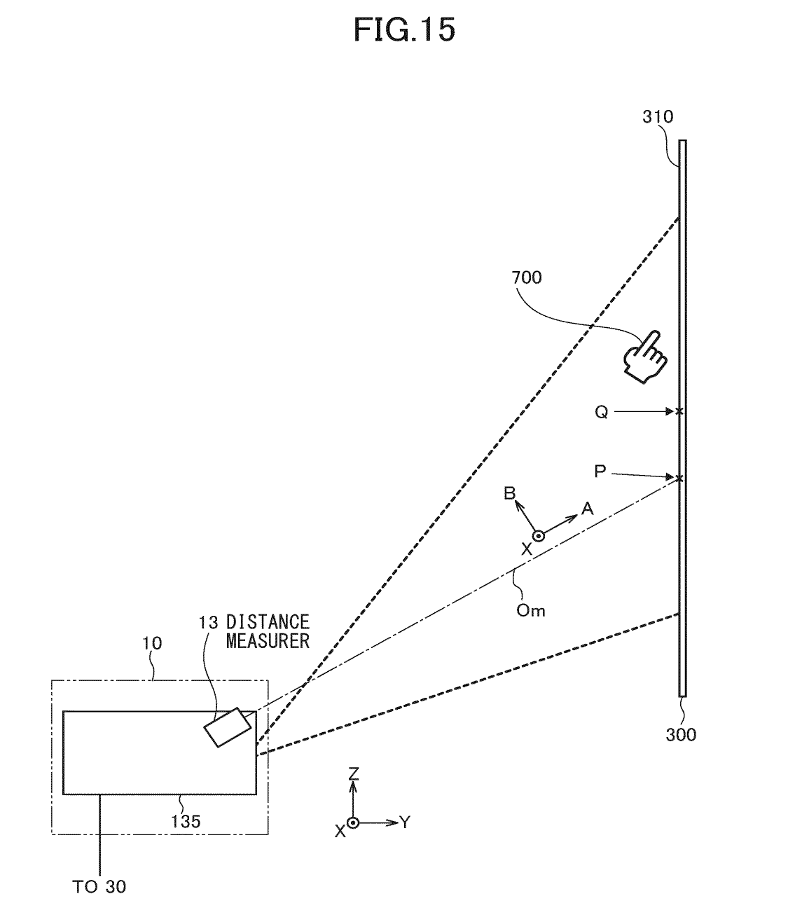

In the embodiment as described above, the distance measurer 13 may be externally attached in a removable state to the casing 135 through a mounting member (not shown) (see FIG. 15). In this case, the depth map acquired in the distance measurer 13 is notified to the processor 15 inside the casing 135 through a cable or the like. In addition, in this case, the distance measurer 13 can be disposed in a position remote from the casing 135.

In the embodiment, at least a part of the processing in the processor 15 may be executed by the image management device 30. For example, if the processing of acquiring the input operation information is executed by the image management device 30, the depth map acquired by the distance measurer 13 is notified to the image management device 30 through the cable and so on, or wireless communication.

In the embodiment, at least a part of the processing in the processor 15 may be executed by the calculator 133. For example, the processing (steps S403 to S417) of detecting the contact in the processing of acquiring the input operation information may be executed in the calculator 133.

In the above-mentioned embodiment, the projector apparatus 10 may include a plurality of distance measurers 13. For example, if a view angle relating to the X axis direction is very large, it is prefer for a low cost to arrange a plurality of distance measurers 13 having imaging optical systems restraining the view angle along the X axis direction, rather than covering the view angle with one distance measurer 13 including an imaging optical system having a super wide-angle. That is to say, a projector apparatus having the super wide-angle in the X axis direction can be realized with a low cost.

In the embodiment, the light emitter 131 of the distance measurer 13 may be configured to emit structured light, as one example as shown in FIG. 16. Here, the structured light means light such as stripe-shaped light and matrix-shaped light suitable for a known Structured Light Method. Of course, an irradiation range of the light is wider than that of the projection image. Since the emitted light is the near infrared light, there is no defect which becomes hard to see the projection image. At this time, the imager 132 images light which is reflected on the imaging object, deformed, and structured. The calculator 133 compares the light emitted from the light emitter 131 with the light imaged in the imager 132 and obtains the depth map based on a triangulation method. This is referred to as a so-called pattern projection method.

In the embodiment, the light emitter 131 of the distance measurer 13 may be configured to emit light in which strength is modulated with a predetermined frequency, as one example as shown in FIG. 17. Of course, an irradiation range of the light is wider than that of the projection image. Since the emitted light is the near infrared light, there is no defect which becomes hard to see the projection image. The imager 132 includes one two-dimensional imaging element in which a phase difference can be measured and an imaging optical system. At this time, the imager 132 is configured to image light which is reflected on the imaging object and in which the phase is sifted. The calculator 133 compares the light emitted from the light emitter 131 with the light imaged in the imager 132 and obtains the depth map based on a time difference and a phase difference. This is referred to as a so-called Time-Of-Flight (TOF) method.

In the embodiment, the light emitter 131 of the distance measurer 13 may be configured to emit the light providing the imaging object with the texture, as one example as shown in FIG. 18. Of course, an irradiation range of the light is wider than that of the projection image. Since the emitted light is the near infrared light, there is no defect which becomes hard to see the projection image. Here, the distance measurer 13 includes two imagers 132 that image a texture pattern projected on the imaging object (see FIG. 8). Therefore, two optical axes are arranged to correspond to the imagers. The calculator 133 calculates the depth map based on a parallax between images imaged by the two imagers 132. In other words, the calculator 133 executes processing referred to as a stereo parallelization for each image and converts images when it is supposed that the two optical axes are parallel. Therefore, the two optical axes may be not parallel. This is referred to as a so-called stereo method. Note that the optical axes after the stereo parallelization is made are overlapped to each other as viewed from the X axis direction (see FIG. 19) and correspond to the optical axis of the distance measurer 13 in the above-mentioned embodiment.

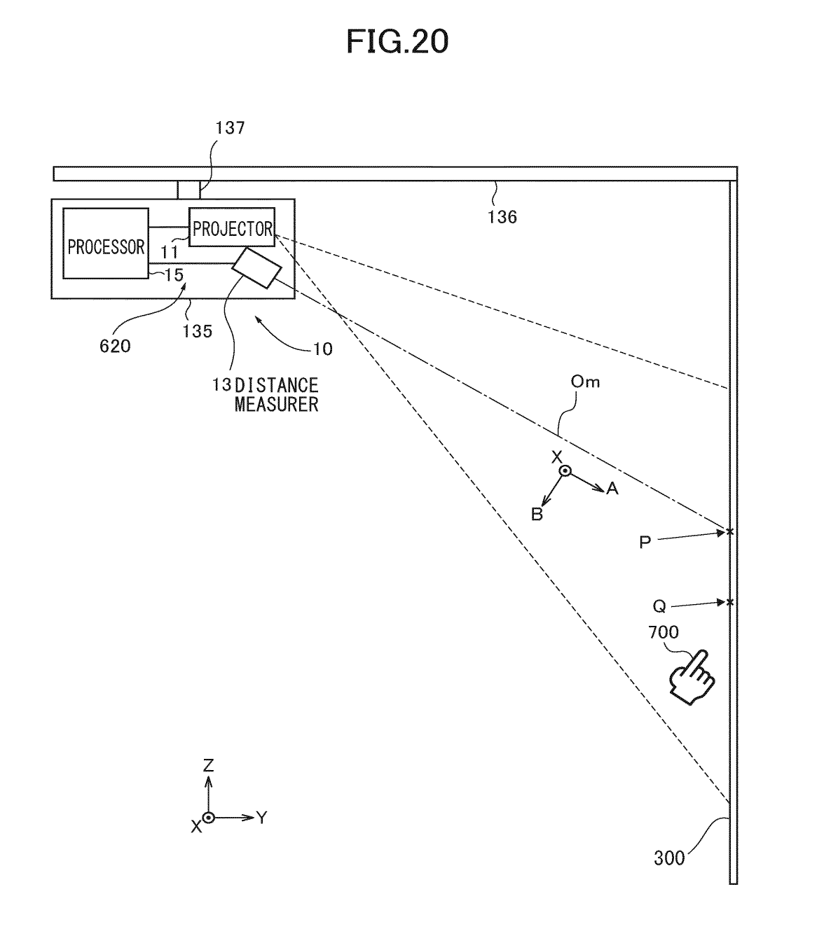

In the embodiment, although the case where the projector apparatus 10 is placed on the mounter 400 and employed has been described, the projector apparatus is not limited to this configuration. For example, the projector apparatus 10 may be used by being suspended from a ceiling 136, as shown in FIG. 20. In the embodiment, the projector apparatus 10 is fixed to the ceiling 136 through a suspension member 137.

In the embodiment, the projection surface is not limited to a planar surface. Note that, in a system of determining the contact by the closest point to the screen in the finger area and the projection surface, not by the fingertip, there is possibility of misdetection if the projection surface is not the planar surface.

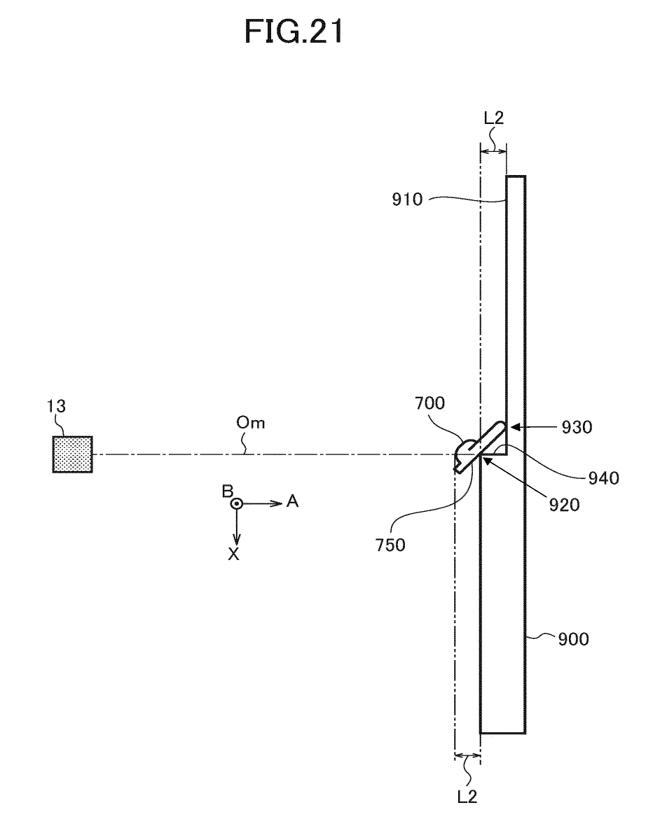

The distance measurer 13 and the processor 15 can be used even in a case where there is a step 940 on a contact target surface 910 of a contacted object 900, as one example as shown in FIG. 21. In this case, even if the other portion of the input operator 700 except for the tip of the input operator 700 is in contact with the step 940, it is possible to decide the fingertip and determine the contact without the misdetection.

For example, if a back 750 of a user's hand touches a corner 920 of the step 940, comes in contact with the step 940, a conventional method determines the contact in that state. However, in the embodiment, the back of the hand is not the fingertip candidate. Therefore, the contact in this case is not treated as the determination. Persistently, the fingertip is decided with a distance between the fingertip candidate and the contact target surface and the contact at a contact point 930 can be determined (see FIG. 21). As a result, the misdetection does not occur.

Even in this case, from the three-dimensional information of all tip candidate points Kij, tip candidate points Kij which are in a fixed distance (30 mm in the embodiment) from the contact target surface in the −A direction and are closest to the contact target surface for every the finger area Ri are searched. If the corresponding point Kij exists, it is determined that the point Kij corresponds to the tip of the input operator, and the tip is in contact with the contact target surface.

More specifically, in the embodiment, even if there is the step on the contact target surface 330, it is possible to detect the contact with a high accuracy because the contact is based on the three-dimensional information of the contact target surface.

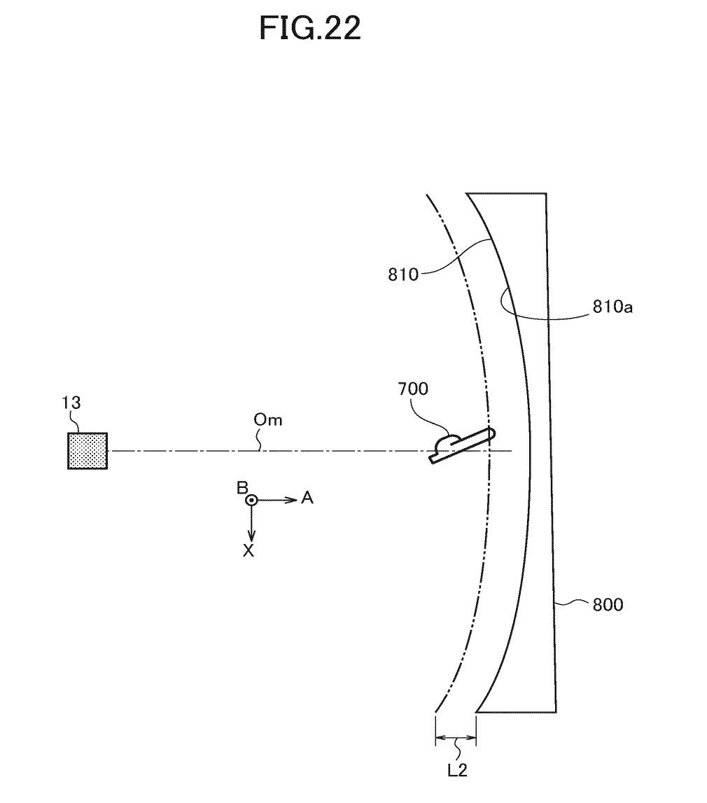

The distance measurer 13 and the processor 15 can be employed even in the case where a contact target surface 810 of a contacted object 800 includes a curved surface 810a as shown in FIG. 22 as one example. For example, the contacted object may be a board employed in a primary school or middle school. Even in this case, it is possible to detect the contact with a high accuracy because the contact is based on the three-dimensional information of the contact target surface.

The distance measurer 13 and the processor 15 can be employed even in an electronic board apparatus 500 or digital signage apparatus 600.

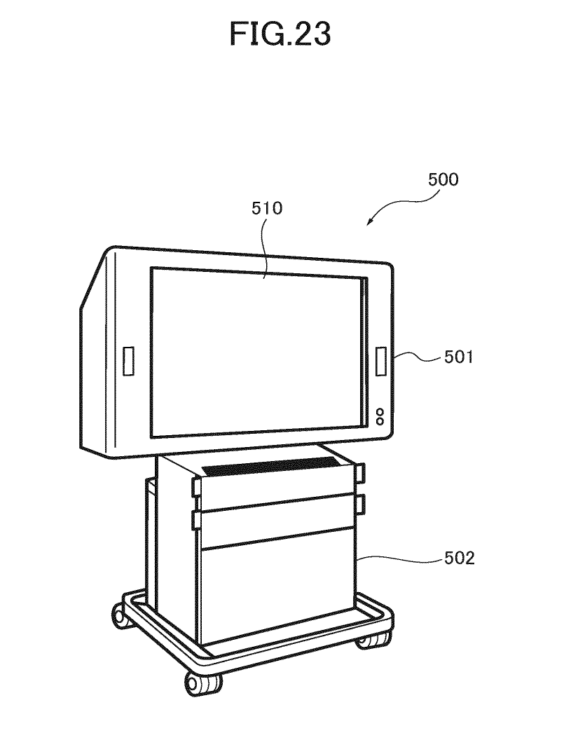

FIG. 23 illustrates one example of the electronic board apparatus 500. The electronic board apparatus 500 is composed of a panel part 501 containing a projection panel (contacted object) on which various menus and command results are displayed and a coordinate input unit, a storage part containing a controller and a projector unit, a stand that supports the panel part 501 and the storage part at a predetermined height, and a device container 502 containing a computer, a scanner, a printer, a video player, and so on (see JP2002-278700A). The contact detection apparatus 620 including the distance measurer 13 and the processor 15 is contained in the device container 502. The contact detection apparatus 620 is appeared by being drawn out from the device container 502. The contact detection apparatus 620 detects contact of the input operator 700 and the projection panel. The communication between the controller and the processor 15 may be executed through cable communication using a USB cable and so on, or wireless communication.

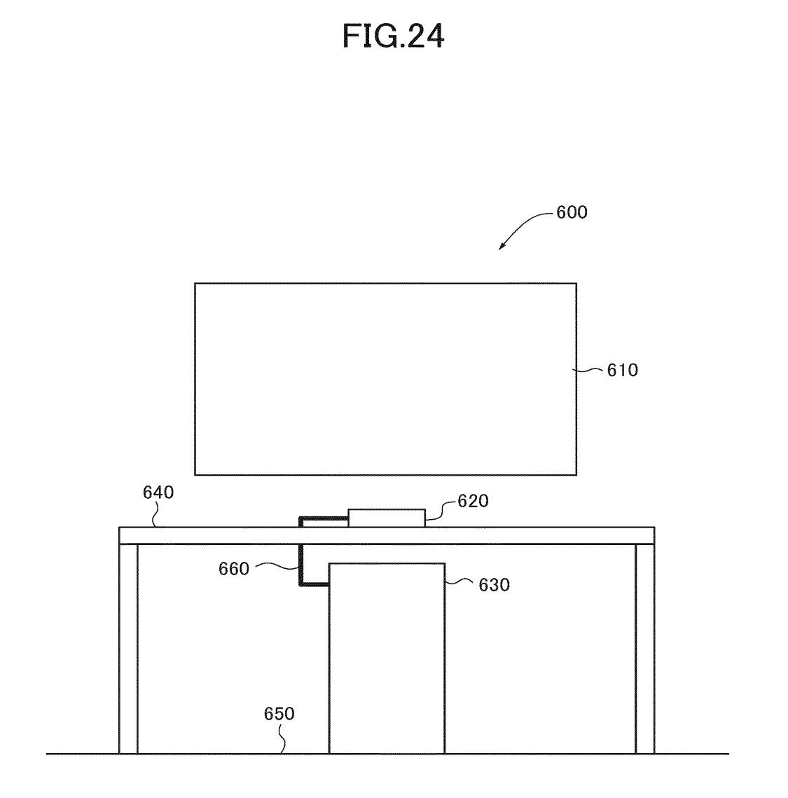

FIG. 24 illustrates one example of the digital signage apparatus 600. The digital signage apparatus 600 includes a glass member 610 which corresponds to the contacted object. A surface of the glass member 610 corresponds to the projection surface 310. An image is rear-projected by a projector 630 from a rear of the glass member 610. The contact detection apparatus 620 including the distance measurer 13 and the processor 15 is disposed on a base 640. The communication between the projector 630 and the processor 15 is executed through a USB cable 660. Thereby, the digital signage apparatus 620 can have an interactive function. Here, reference numeral 650 denotes a floor.

In this way, the distance measurer 13 and the processor 15 are suitable for a device having the interactive function or device wishing to add the interactive function.

Although the several embodiments of the present invention have been described, it should be noted that the present invention is not limited to these embodiments, various modifications and changes can be made to the embodiments by those skilled in the art as long as such modifications and changes are within the scope of the present invention as defined by the Claims.

What is claimed is:

1. A contact detection apparatus that detects contact of a contactor and a contacted object, the contact detection apparatus comprising:
an imaging device that acquires three-dimensional imaging information of the contactor and the contacted object;
a setter that sets a contact target surface based on the three-dimensional imaging information of the contacted object from the imaging device;
a candidate detector that converts the three-dimensional imaging information of the contactor from the imaging device into two-dimensional information and detects an end portion candidate of the contactor based on the two-dimensional information and the contact target surface; and
a contact determiner that decides an end portion of the contactor and determines the contact of the contactor and the contacted object based on the three-dimensional imaging information of the end portion candidate and the contact target surface.

2. The contact detection apparatus according to claim 1, wherein the contact determiner decides an end portion candidate in that a distance from the contact target surface is a predetermined value or less and that is closest to the contact target surface as an end portion of the contactor, and determines that the contactor is in contact with the contact target surface.

3. The contact detection apparatus according to claim 1, wherein the candidate detector converts the tree-dimensional imaging information into the two-dimensional information by projection conversion.

4. The contact detection apparatus according to claim 1, wherein the candidate detector executes convex hull processing for the two-dimensional information to detect the end portion candidate.

5. The contact detection apparatus according to claim 1, wherein the candidate detector extracts an area in which the contactor is included and three-dimensional imaging information of the area into two-dimensional information, when the contactor exists in a predetermined distance from the contact target surface.

6. The contact detection apparatus according to claim 1, wherein the setter sets the contact target surface in a position remote by a predetermined distance from the contacted object.

7. The contact detection apparatus according to claim 1, wherein the contacted object includes a curved surface.

8. The contact detection apparatus according to claim 1, wherein the contacted object includes a step.

9. The contact detection apparatus according to claim 1, wherein the imager includes a light emitter that emits near infrared light and at least one two-dimensional imaging element.

10. A projector apparatus comprising a projector that projects an image on a projection surface; and
the contact detection apparatus as claimed in claim 1 to detect the contact of the projection surface and the contactor.

11. An electronic board apparatus comprising the contact detection apparatus as claimed in claim 1.

12. A digital signage apparatus comprising the contact detection apparatus as claimed in claim 1.

13. A projector system comprising the projector apparatus as claimed in claim 10 and a controller that controls the image based on input operation acquired by the projector apparatus.

14. A contact detection method that detects contact of a contactor and a contacted object, comprising:
setting a contact target surface based on three-dimensional imaging information of the contacted object;
converting three-dimensional imaging information of the contactor into two-dimensional information and detecting an end portion candidate of the contactor based on the two-dimensional information and the contact target surface; and
deciding an end portion of the contactor and determining the contact of the contactor and the contacted object based on the three-dimensional imaging information of the end portion candidate and the contact target surface.
